(19) United States
(12) Patent Application Publication
(10) Pub. No.: US 2023/0126142 A1
(43) Pub. Date: Apr. 27, 2023

(54) EARLY MESSAGE FOR CONDITIONAL HANDOVER

(71) Applicant: QUALCOMM Incorporated, San Diego, CA (US)

(72) Inventors: Ozcan OZTURK, San Diego, CA (US); Arvind Vardarajan SANTHANAM, San Diego, CA (US)

(21) Appl. No.: 17/938,159

(22) Filed: Oct. 5, 2022

Related U.S. Application Data
(60) Provisional application No. 63/262,855, filed on Oct. 21, 2021.

(51) Int. Cl. H04W 36/30; H04W 36/00

(52) U.S. Cl. CPC H04W 36/30; H04W 36/0061; H04W 36/0016

(57) ABSTRACT

Various aspects of the present disclosure generally relate to wireless communication. In some aspects, a user equipment (UE) may generate, based at least in part on a handover condition being satisfied, a message that indicates that the UE is preparing to leave a source cell for a target cell. The UE may transmit the message before a conditional handover (CHO) is initiated or during a wait timer that is started after the CHO is initiated. Numerous other aspects are described.

### CROSS-REFERENCE TO RELATED APPLICATION

This patent application claims priority to U.S. Provisional Patent Application No. 63/262,855, filed on Oct. 21, 2021, entitled “EARLY BYE MESSAGE FOR CONDITIONAL HANDOVER,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for an early message for conditional handover.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include generating, based at least in part on a handover condition being satisfied, a message that indicates that the UE is preparing to leave a source cell for a target cell. The method may include transmitting the message before a conditional handover (CHO) is initiated or during a wait timer that is started after the CHO is initiated.

Some aspects described herein relate to a method of wireless communication performed by a network entity of a source cell. The method may include receiving, from a UE before initiation of a CHO, a message that indicates that the UE is preparing to leave the source cell for a target cell. The method may include forwarding data to one or more prepared CHO target cells based at least in part on the message.

Some aspects described herein relate to a UE for wireless communication. The UE may include a memory and one or more processors coupled to the memory. The one or more processors may be configured to generate, based at least in part on a handover condition being satisfied, a message that indicates that the UE is preparing to leave a source cell for a target cell. The one or more processors may be configured to transmit the message before a CHO is initiated or during a wait timer that is started after the CHO is initiated.

Some aspects described herein relate to a network entity in a source cell for wireless communication. The network entity in a source cell may include a memory and one or more processors coupled to the memory. The one or more processors may be configured to receive, from a UE before initiation of a CHO, a message that indicates that the UE is preparing to leave the source cell for a target cell. The one or more processors may be configured to forward data to one or more prepared CHO target cells based at least in part on the message.

Some aspects described herein relate to a non-transitory computer-readable medium that stores a set of instructions for wireless communication by a UE. The set of instructions, when executed by one or more processors of the UE, may cause the UE to generate, based at least in part on a handover condition being satisfied, a message that indicates that the UE is preparing to leave a source cell for a target cell. The set of instructions, when executed by one or more processors of the UE, may cause the UE to transmit the message before a CHO is initiated or during a wait timer that is started after the CHO is initiated.

Some aspects described herein relate to a non-transitory computer-readable medium that stores a set of instructions for wireless communication by a source cell. The set of instructions, when executed by one or more processors of the source cell, may cause the source cell to receive, from a UE before initiation of a CHO, a message that indicates that the UE is preparing to leave the source cell for a target cell. The set of instructions, when executed by one or more processors of the source cell, may cause the source cell to forward data to one or more prepared CHO target cells based at least in part on the message.

Some aspects described herein relate to an apparatus for wireless communication. The apparatus may include means for generating, based at least in part on a handover condition being satisfied, a message that indicates that the apparatus is preparing to leave a source cell for a target cell. The apparatus may include means for transmitting the message before a CHO is initiated or during a wait timer that is started after the CHO is initiated.

Some aspects described herein relate to an apparatus in a source cell for wireless communication. The apparatus may include means for receiving, from a UE before initiation of a CHO, a message that indicates that the UE is preparing to leave the source cell for a target cell. The apparatus may include means for forwarding data to one or more prepared CHO target cells based at least in part on the message.

Aspects generally include a method, apparatus, system, computer program product, non-transitory computer-readable medium, user equipment, base station, network node, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of transmitting an early bye message.

FIG. 4 is a diagram illustrating an example process performed, for example, by a UE, in accordance with the present disclosure.

FIG. 5 is a diagram illustrating an example process performed, for example, by a network entity in a source cell, in accordance with the present disclosure.

FIGS. 6-7 are diagrams of example apparatuses for wireless communication, in accordance with the present disclosure.

FIG. 8 is a diagram illustrating an example of a disaggregated base station, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

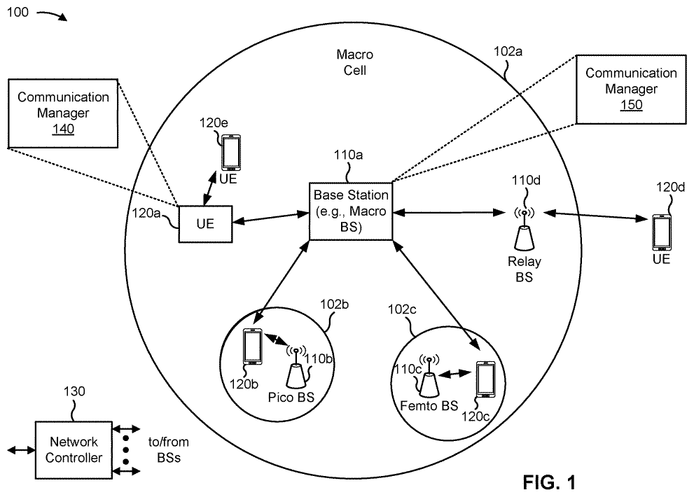

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

In some aspects, the terms “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the terms “base station” or “network entity” may refer to one device configured to perform one or more functions, such as those described herein in connection with the base station 110. In some aspects, the terms “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the terms “base station” or “network entity” may refer to any one or more of those different devices. In some aspects, the terms “base station” or “network entity” may refer to one or more virtual base stations and/or one or more virtual base station functions. For example, in some aspects, two or more base station functions may be instantiated on a single device. In some aspects, the terms “base station” or “network entity” may refer to one of the base station functions and not another. In this way, a single device may include more than one base station.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may generate, based at least in part on a handover condition being satisfied, a message that indicates that the UE is preparing to leave a source cell for a target cell; and transmit the message before a conditional handover (CHO) is initiated or during a wait timer that is started after the CHO is initiated. Additionally, or alternatively, the communication manager 140 may perform one or more other operations described herein.

In some aspects, a network entity (e.g., base station 110) may include a communication manager 150. As described in more detail elsewhere herein, the communication manager 150 may receive, from a UE before initiation of a CHO, a message that indicates that the UE is preparing to leave the source cell for a target cell; and forward data to one or more prepared CHO target cells based at least in part on the message. Additionally, or alternatively, the communication manager 150 may perform one or more other operations described herein.

As indicated above, FIG. 1 is provided as an example. Other examples may differ from what is described with regard to FIG. 1.

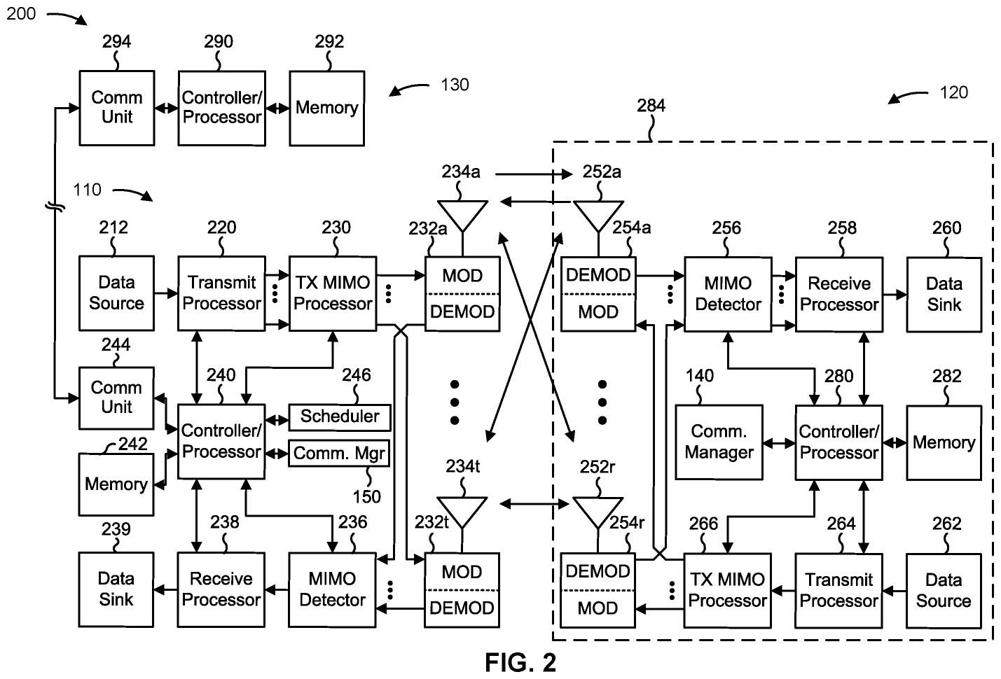

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

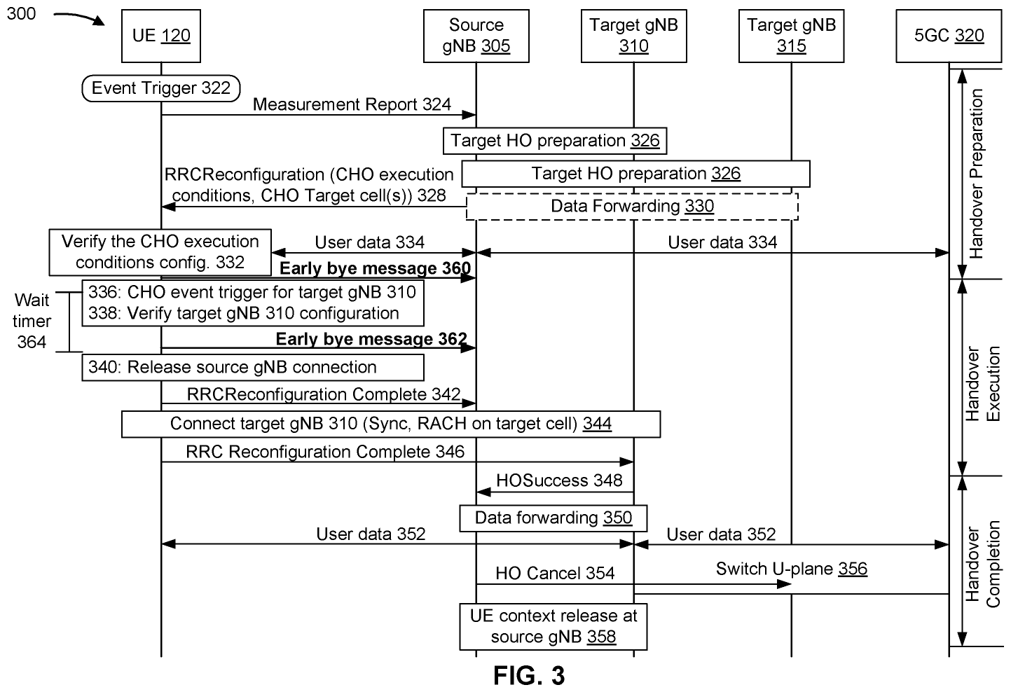

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-8).

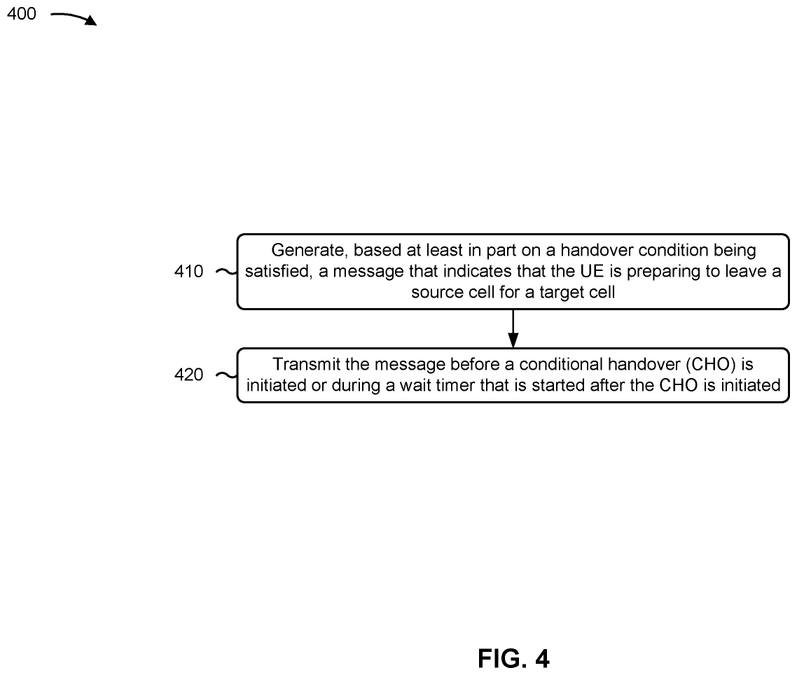

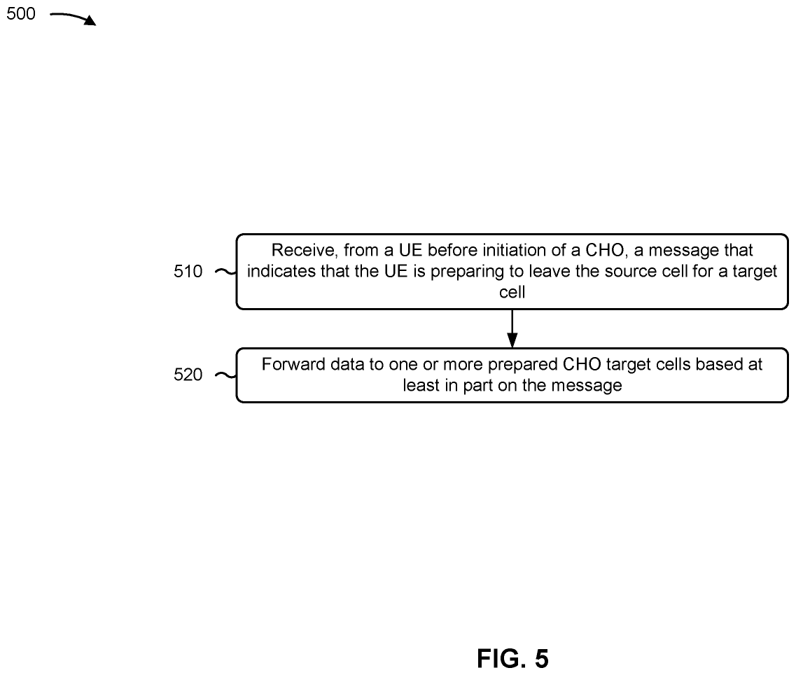

The controller/processor of a network entity (e.g., the controller/processor 240 of the base station 110), the controller/processor 280 of the UE 120, and/or any other component(s) of FIG. 2 may perform one or more techniques associated with an early bye message for CHO, as described in more detail elsewhere herein. For example, the controller/processor 240 of the base station 110, the controller/processor 280 of the UE 120, and/or any other component(s) of FIG. 2 may perform or direct operations of, for example, process 400 of FIG. 4, process 500 of FIG. 5, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 400 of FIG. 4, process 500 of FIG. 5, and/or other processes as described herein. In some examples, executing instructions may include running the instructions, converting the instructions, compiling the instructions, and/or interpreting the instructions, among other examples.

In some aspects, the UE 120 includes means for generating, based at least in part on a handover condition being satisfied, a message that indicates that the UE is preparing to leave a source cell for a target cell; and/or means for transmitting the message before a CHO is initiated or during a wait timer that is started after the CHO is initiated. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) in a source cell includes means for receiving, from a UE before initiation of a CHO, a message that indicates that the UE is preparing to leave the source cell for a target cell; and/or means for forwarding data to one or more prepared CHO target cells based at least in part on the message. The means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of transmitting an early bye message. A source network entity, such as gNB 305 (e.g., base station 110), may provide a source cell for a UE (e.g., UE 120). The UE 120 may be handed over from the source cell to a candidate target cell provided by either candidate target gNB 310 (e.g., a base station 110) or candidate target gNB 315 (e.g., a base station 110). Each of the gNBs may be connected to a 5G core network (5GC 320).

CHO may include several phases. The phases may include a handover (HO) preparation phase, a handover execution phase, and a handover completion phase. In some aspects, the UE 120 may make and report measurements during the handover preparation phase. There may be multiple candidate target cells, such as target cells provided by target gNB 310 and target gNB 315. Selection to a particular target cell, such as the target cell provided by target gNB 310, may be based on meeting a condition of the particular target cell. During the handover execution phase, the UE 120 may execute the handover by performing a random access channel (RACH) procedure with the target gNB 310 and establishing a radio resource control (RRC) connection with the target gNB 310. During the handover completion phase, the source gNB 305 may forward stored communications associated with the UE 120 to the target gNB 310, and the UE 120 may be released from the source connection to the source gNB 305.

CHO may involve multiple steps in each of the handover phases. As shown by reference number 322, the UE 120 may determine that an event trigger or handover condition is being met. The UE 120 may perform measurements (such as on signals of the source cell or neighboring cells) and transmit a measurement report to the source gNB 305 of the source cell, as shown by reference number 324. The measurement report may indicate, for example, an RSRP parameter, an RSRQ parameter, an RSSI parameter, or a signal-to-interference-plus-noise ratio (SINR) parameter.

As shown by reference number 326, the source gNB 305 and each candidate target gNB of the candidate target cells may prepare for a handover. As shown by reference number 328, the source gNB 305 may transmit an RRC reconfiguration message to the UE 120. The RRC reconfiguration message may include a handover command instructing the UE 120 to execute the conditional handover from the source gNB 305 to one of the candidate target gNBs. The handover command may include information associated with each candidate target gNB, including a condition (e.g., threshold) for a handover to a particular candidate target gNB, such as target gNB 310. The UE 120 may simultaneously maintain the source connection to the source gNB 305 and a target connection to the target gNB 310.

As shown by reference number 330, the source gNB 305 may start forwarding user data when the target cell is prepared (referred to as “early forwarding”). When the CHO is executed successfully, the source gNB 305 may also forward data (referred to as “late forwarding”). In some cases, a gNB may implement late forwarding, since early forwarding could be wasteful if the CHO is never executed. On the other hand, there is potential data lost with late forwarding, since after the time the UE 120 leaves the source gNB 305 and the CHO is completed, the source gNB 305 will continue transmitting data to the UE 120 which will not be received, and such data either will need to be recovered by retransmission or will be lost completely.

In some aspects, the RRC reconfiguration message may include a candidate target cell configuration and CHO execution conditions by which the UE 120 is to prepare for a CHO. The execution conditions may include an A3 conditional event, where measurements for a candidate target cell become better by a first threshold amount (e.g., specified offset of 3 decibels (dB)) than measurements for a current cell (PCell or PSCell). The execution conditions may include an A5 event, where the measurements at the current cell become worse by a second threshold amount (e.g., offset in dB) and the measurements for the candidate target cell become better than a third threshold amount (e.g., absolute amount in dB). The UE 120 may monitor for conditional events such as A3 and A5 during a time to trigger (TTT) period, which may involve a TTT timer.

An RRC container may carry a candidate target cell configuration, and the source gNB 305 may not be allowed to alter any content of the candidate target cell configuration. Multiple candidate target cells (e.g., up to 8) may be configured. These may include delta configurations, which may be configurations that provide only a difference between a candidate target cell configuration and a configuration of the source gNB 305. The source gNB 305 may coordinate with a target gNB when there are any source or target changes and may update the UE 120. As shown by reference number 332, the UE 120 may verify the validity of the configuration of the source gNB 305 configuration upon reception. The CHO execution condition configuration may specify that the CHO entry condition is to be satisfied before the TTT ends (e.g., with an exit condition). A CHO execution condition configuration may include triggering quantities of RSRP, RSRP, and SINR that are configured simultaneously. There may be a single reference signal type, such as a synchronization signal block (SSB) or a channel state information reference signal (CSI-RS), per CHO candidate target cell.

If reconfiguration with synchronization (with or without key change) happens before CHO execution conditions are met, the UE 120 may delete stored CHO configurations. When a radio link failure occurs, if a selected target cell is a CHO candidate target cell, the UE 120 may perform CHO completion. If not, legacy reestablishment may be performed. As shown by reference number 334, UE 120 may be transmitting user data to and receiving user data from the source gNB 305, which communicates the user data with the 5GC 320.

As shown by reference number 336, the UE 120 may determine that an event is triggered for handover to the target cell for the target gNB 310. As shown by reference number 338, the UE 120 may verify a configuration of the target gNB 310. Verification may take place at an earlier time. As shown by reference number 340, the UE 120 may release the source connection to the source cell and execute the CHO to the target gNB 310. As shown by reference number 342, the UE 120 may transmit an RRC reconfiguration complete message to the source gNB. The source gNB 305 and the target gNB 310 may exchange user data for the UE 120.

As shown by reference number 344, the UE 120 may connect to the target gNB 310 as part of the handover execution phase. The UE 120 may connect to the target gNB 310 by performing a RACH procedure with the target gNB 310. Upon successfully establishing a connection with the target gNB 310, the UE 120 may transmit an RRC reconfiguration completion message to the target gNB 310, as shown by reference number 346. A difference between CHO and legacy handover is that the UE 120 does not need to send the measurement report to the source gNB 305 and wait for a handover command. This makes the CHO more robust for cases when the source cell conditions degrade rapidly. In addition, CHO improves the handover latency by eliminating reporting and handover command reception.

As shown by reference number 348, the target gNB 310 may transmit a handover connection setup complete message (HOSuccess) to the source gNB 305. Reception of the handover connection setup complete message by the target gNB 310 may trigger the source gNB 305 to stop transmitting data to the UE 120 or to stop receiving data from the UE 120.

When the CHO execution condition is met for a candidate target cell, a legacy T304 timer may be used for CHO completion. The UE 120 does not monitor source cell transmissions afterwards and does not receive new RRC messages. The UE 120 stops transmissions to the source cell. The UE 120 may transmit a handover complete message to the target cell, as in legacy handover. The UE 120 may stop evaluating the triggering condition of other candidate cells during CHO execution (may still perform measurements on them).

As shown by reference number 350, the source gNB 305 may forward communications associated with the UE 120 to the target gNB 310 or to notify the target gNB 310 of a status of one or more communications with the UE 120. The source gNB 305 may notify the target gNB 310 regarding a packet data convergence protocol (PDCP) status associated with the UE 120 or a serial number to be used for a downlink communication with the UE 120. As shown by reference number 352, the UE 120 may communicate user data with the target gNB 310.

If CHO completion fails (e.g., T304 expires), the UE 120 may perform cell selection using a legacy procedure. If the selected cell is a CHO candidate, the UE 120 may attempt to complete CHO to the selected cell. This is an optional UE capability. Otherwise, the UE 120 follows legacy reestablishment. As shown by reference number 354, the source gNB 305 may transmit a handover cancel message to any candidate target gNBs that the UE 120 did not select for handover. For example, the source gNB 305 may transmit a handover cancel message to the target gNB 315.

As shown by reference number 350, the target gNB 310 may communicate with the 5GC 320 to switch a user plane path of the UE 120 from the source gNB 305 to the target gNB 310, as shown by reference number 356. Prior to switching the user plane path, downlink communications for the UE 120 may be routed through the 5GC 320 to the source gNB 305. After the user plane path is switched, downlink communications for the UE 120 may be routed through the 5GC 320 to the target gNB 310. As shown by reference number 358, the source gNB 305 may release a UE context for the UE 120.

In dual connectivity scenarios, a secondary node (SN) of a cell may be used with a primary node of a cell to increase a bandwidth or a performance for a UE. Traffic on the primary node and the SN may be aggregated. In such a scenario, the UE may change SNs. This may be referred to as conditional “primary secondary cell (PSCell) change” for NR. In some aspects, the change may be performed with operations comparable to a dual active protocol stack (DAPS) handover, a conditional handover, or another type of handover. The UE may decide to change from the source secondary cell (SCell) to a target SCell. The UE may decide this change based on, for example, measurements from the source SCell or the target SCell.

The CHO may include a DAPS handover from the source gNB 305 to the target gNB 310. The UE 120 may connect to the target gNB 310 as part of the handover execution phase and transmit uplink data, uplink control information, or an uplink reference signal (such as a sounding reference signal) to the source gNB 305, or may receive downlink data, downlink control information, or a downlink reference signal from the source gNB 305. While the UE 120 is performing the RACH procedure with the target gNB 310, the UE 120 may transmit uplink data, uplink control information, or an uplink reference signal (such as a sounding reference signal) to the source gNB 305, or may receive downlink data, downlink control information, or a downlink reference signal from the source gNB 305. Because the DAPS handover may be a make before break (MBB) handover, the UE 120 may simultaneously maintain the source connection with the source gNB 305 and the target connection with the target gNB 310.

In some aspects, to make the data forwarding between gNBs more efficient, the UE 120 may provide an indication to the source BS 305 when the UE 120 is to execute a CHO. This indication may be referred to as a “bye message” as if to say “bye” to the source gNB 305. However, if the UE 120 is to wait to receive a response to the bye message before a CHO execution initiates, this would delay CHO execution and thus reduce the robustness and latency benefits of CHO.

According to various aspects described herein, if CHO execution appears likely to occur, the UE 120 may transmit a message, such as an “early bye message,” before the CHO execution initiates as indicated by reference number 336 and not wait for a response to continue with CHO execution. The early transmission of the bye message is shown by reference number 360. That is, the bye message may be an opportunistic bye message to start forwarding of data from the source gNB 305 to the target gNB 310 in anticipation of the CHO and to forward the data earlier than CHO completion (earlier than indicated by reference number 350). For example, the UE 120 may transmit the bye message when the event TTT timer associated with CHO measurements reaches a certain point (e.g., a configured percentage of its value or a configured time point). The UE 120 may generate the bye message based at least in part on a handover condition being satisfied, which may be at the certain (earlier) point of the TTT timer. This may involve another timer that is started when the event entering condition is satisfied. The handover condition may include a threshold gradient of signal strength, a threshold gradient of signal quality, a threshold Doppler parameter, or a threshold velocity of the UE. The handover condition may be satisfied, for example, when a measured gradient of signal strength meets or exceeds a gradient threshold of signal strength, when a measured gradient of signal quality meets or exceeds a gradient threshold of signal quality, when a Doppler parameter meets a Doppler parameter threshold, or when a velocity of the UE 120 meets or exceeds a velocity threshold. The handover condition may include other aspects of UE mobility and signal characteristics. In some aspects, the bye message may be generated when multiple events occur or when some other entering condition occurs.

Alternatively, the UE 120 may transmit the bye message during a wait timer that starts when the CHO is initiated. As shown by reference number 362, the UE 120 may transmit the bye message after the CHO is triggered or initiated (reference number 336). The UE 120 may start a wait timer 364 when the CHO is initiated, and the UE 120 may transmit the bye message during the wait timer 364. The wait timer 364 may be shorter in time than when the source gNB 305 connection is released (reference number 340). The wait timer 364 may be configured by a gNB and may control how long the UE 120 is to wait to send the bye message. The UE 120 may execute the CHO when the wait timer 364 expires. The UE 120 may stop the wait timer 364 if the CHO is not triggered. By transmitting an early bye message, the UE 120 may provide for earlier forwarding of data from the source gNB 305 to a target gNB in anticipation of the CHO. This may reduce latency and loss of user data that may occur if the UE 120 has to wait until execution of the CHO has completed.

In some aspects, the UE 120 may transmit the bye message in an RRC message (e.g., UE Assistance Information (UAI) or an RRC message specific to handover). The UE 120 may transmit the bye message in a medium access control control element (MAC CE). The UE 120 may transmit the bye message in a special scheduling request (SR) that is specific to handover or to CHO. There may be a different SR for each target cell. The UE 120 may transmit the bye message in a special CSI report.

In some aspects, the bye message may include an identifier (ID) or physical cell ID (PCI) of a cell for which CHO is about to be triggered (e.g., gNB 305). The bye message may include a configuration index that identifies the target cell. The UE 120 may transmit the bye message on a primary cell (PCell) or a secondary cell (SCell).

In some aspects, if the UE 120 is connected to a relay station at the source cell, the UE 120 may transmit the bye message to the relay station, which can forward the message to the gNB. For an RRC message, the forwarding may be transparent. For a physical (PHY) layer and or a medium access control (MAC) layer message, the relay station may transmit a Uu message to the gNB 305 that includes an ID of the UE 120. The UE 120 may also transmit the bye message in a new PC5 message to a relay station, and the relay station may forward the bye message on behalf of the UE 120. The UE 102 may use any other radio access technology, including non-cellular technologies (e.g., WiFi, Bluetooth® protocols) to transmit the bye message. In other words, the relay station may forward a transparent bye message or decode and retransmit the bye message. In some aspects, for dual connectivity, the UE 120 may transmit the bye message to the source secondary node (SN) when conditional PSCell change (CPC) is configured. The handover type for CHO may be legacy handover or DAPS handover.

In some aspects, when the source gNB 305 receives the bye message, the source gNB may start forwarding data to one or more prepared CHO target cells. The gNB 305 may start forwarding data earlier than at reference number 350 (before reference number 344). If the bye message includes a target cell ID, the gNB 305 may forward data only to that target cell ID, such as to target gNB 310. If the bye message does not include the target cell ID, the gNB 305 may forward data to all prepared CHO target cells.

After sending the bye message, the UE 120 may release the connection to the source gNB 305 and complete the CHO. The UE 120 may also wait for a response to the bye message from the gNB 305, at least before the wait timer 364 expires.

As indicated above, FIG. 3 is provided as an example. Other examples may differ from what is described with regard to FIG. 3.

FIG. 4 is a diagram illustrating an example process 400 performed, for example, by a UE, in accordance with the present disclosure. Example process 400 is an example where the UE (e.g., UE 120) performs operations associated with transmitting an early bye message for CHO.

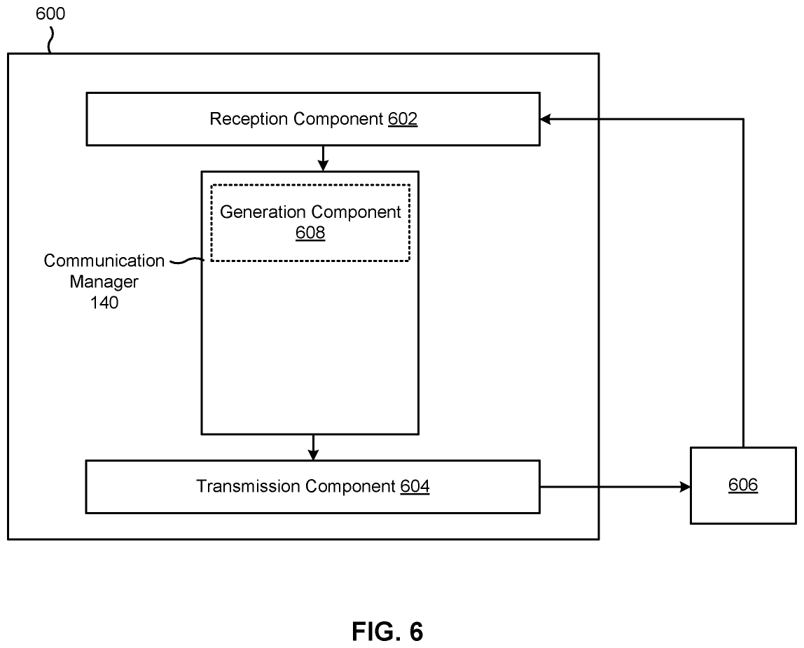

As shown in FIG. 4, in some aspects, process 400 may include generating, based at least in part on a handover condition being satisfied, a message (e.g., bye message) that indicates that the UE is preparing to leave a source cell for a target cell (block 410). For example, the UE (e.g., using communication manager 140 and/or generation component 608 depicted in FIG. 6) may generate, based at least in part on a handover condition being satisfied, a bye message that indicates that the UE is preparing to leave a source cell for a target cell, as described above.

As further shown in FIG. 4, in some aspects, process 400 may include transmitting the bye message before a CHO is initiated or during a wait timer that is started after the CHO is initiated (block 420). For example, the UE (e.g., using communication manager 140 and/or transmission component 604 depicted in FIG. 6) may transmit the bye message before a CHO is initiated or during a wait timer that is started after the CHO is initiated, as described above.

Process 400 may include additional aspects, such as any single aspect or any combination of aspects described below and/or in connection with one or more other processes described elsewhere herein.

In a first aspect, process 400 includes monitoring for a response to the bye message until the wait timer expires.

In a second aspect, alone or in combination with the first aspect, process 400 includes transmitting a CHO complete message after transmitting the bye message.

In a third aspect, alone or in combination with one or more of the first and second aspects, process 400 includes transmitting a CHO complete message after the wait timer expires.

In a fourth aspect, alone or in combination with one or more of the first through third aspects, the handover condition includes reaching a configured time point within a TTT for a measurement event used for the CHO.

In a fifth aspect, alone or in combination with one or more of the first through fourth aspects, the handover condition includes one or more of a threshold gradient of signal strength, a threshold gradient of signal quality, a threshold Doppler parameter, or a velocity of the UE.

In a sixth aspect, alone or in combination with one or more of the first through fifth aspects, the handover condition includes multiple measurement events.

In a seventh aspect, alone or in combination with one or more of the first through sixth aspects, transmitting the bye message includes transmitting the bye message in an RRC message, a MAC CE, an SR to handover, or a CSI report specific to handover.

In an eighth aspect, alone or in combination with one or more of the first through seventh aspects, the bye message includes a cell ID or PCI of a cell for which the CHO is to be initiated.

In a ninth aspect, alone or in combination with one or more of the first through eighth aspects, the bye message includes a configuration index that identifies the target cell.

In a tenth aspect, alone or in combination with one or more of the first through ninth aspects, transmitting the bye message includes transmitting the bye message in a primary cell.

In an eleventh aspect, alone or in combination with one or more of the first through tenth aspects, transmitting the bye message includes transmitting the bye message in an SCell or a PSCell.

In a twelfth aspect, alone or in combination with one or more of the first through eleventh aspects, transmitting the bye message includes transmitting the bye message to a secondary node in a dual connectivity mode for conditional PSCell change.

In a thirteenth aspect, alone or in combination with one or more of the first through twelfth aspects, transmitting the bye message includes transmitting the bye message to a relay station at the source cell.

In a fourteenth aspect, alone or in combination with one or more of the first through thirteenth aspects, transmitting the bye message includes transmitting the bye message in a PC5 message or a non-cellular message.

In a fifteenth aspect, alone or in combination with one or more of the first through fourteenth aspects, the CHO includes a dual active protocol stack handover.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, by a network entity (e.g., base station 110), in accordance with the present disclosure. Example process 500 is an example where the network entity (e.g., base station 110, gNB 310) performs operations associated with receiving an early bye message for CHO.

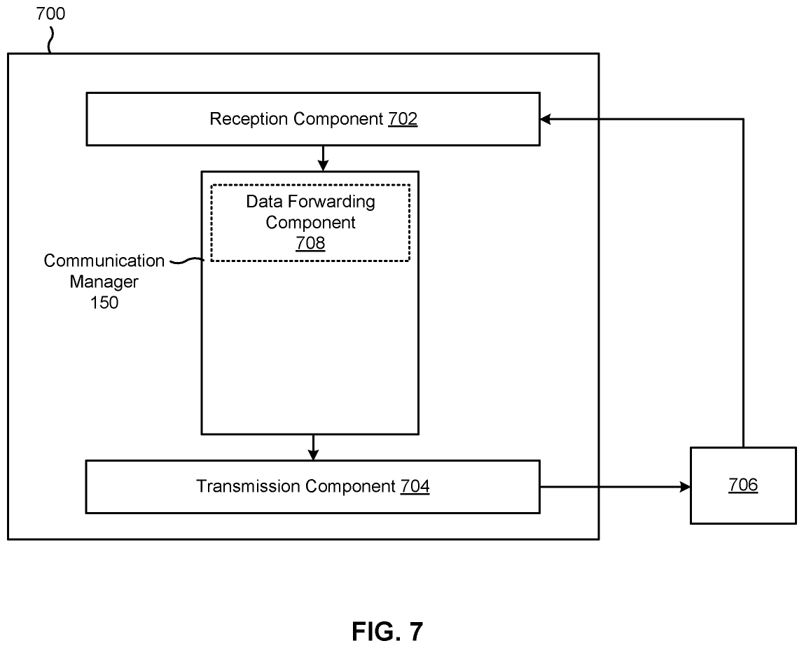

As shown in FIG. 5, in some aspects, process 500 may include receiving, from a UE before initiation of a CHO, a message (e.g., a bye message) that indicates that the UE is preparing to leave the source cell for a target cell (block 510). For example, the network entity (e.g., using communication manager 150 and/or reception component 702 depicted in FIG. 7) may receive, from a UE before initiation of a CHO, a bye message that indicates that the UE is preparing to leave the source cell for a target cell, as described above.

As further shown in FIG. 5, in some aspects, process 500 may include forwarding data to one or more prepared CHO target cells based at least in part on the bye message (block 520). For example, the network entity (e.g., using communication manager 150 and/or data forwarding component 708 depicted in FIG. 7) may forward data to one or more prepared CHO target cells based at least in part on the bye message, as described above.

Process 500 may include additional aspects, such as any single aspect or any combination of aspects described below and/or in connection with one or more other processes described elsewhere herein.

In a first aspect, process 500 includes transmitting a response to the bye message.

In a second aspect, alone or in combination with the first aspect, the one or more prepared CHO target cells include the target cell identified by a cell identifier in the bye message.

In a third aspect, alone or in combination with one or more of the first and second aspects, the one or more prepared CHO target cells include multiple prepared CHO target cells if the bye message does not include a cell identifier.

In a fourth aspect, alone or in combination with one or more of the first through third aspects, receiving the bye message includes receiving the bye message in an RRC message, a MAC CE, an SR specific to handover, or a CSI report specific to handover.

In a fifth aspect, alone or in combination with one or more of the first through fourth aspects, the bye message includes a cell identifier of a cell for which the CHO is to be initiated.

In a sixth aspect, alone or in combination with one or more of the first through fifth aspects, the bye message includes a configuration index that identifies the target cell.

In a seventh aspect, alone or in combination with one or more of the first through sixth aspects, receiving the bye message includes receiving the bye message in a primary cell.

In an eighth aspect, alone or in combination with one or more of the first through seventh aspects, receiving the bye message includes receiving the bye message in an SCell or a PSCell.

In a ninth aspect, alone or in combination with one or more of the first through eighth aspects, receiving the bye message includes receiving the bye message from a relay station.

In a tenth aspect, alone or in combination with one or more of the first through ninth aspects, the CHO includes a dual active protocol stack handover.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE (e.g., UE 120), or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, a network entity, or another wireless communication device) using the reception component 602 and the transmission component 604. As further shown, the apparatus 600 may include the communication manager 140. The communication manager 140 may include a generation component 608, among other examples.

In some aspects, the apparatus 600 may be configured to perform one or more operations described herein in connection with FIGS. 1-3. Additionally, or alternatively, the apparatus 600 may be configured to perform one or more processes described herein, such as process 400 of FIG. 4. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the UE described in connection with FIG. 2.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the UE described in connection with FIG. 2. In some aspects, the transmission component 604 may be co-located with the reception component 602 in a transceiver.

The generation component 608 may generate, based at least in part on a handover condition being satisfied, a message (e.g., a bye message) that indicates that the UE is preparing to leave a source cell for a target cell. The transmission component 604 may transmit the bye message before a CHO is initiated or during a wait timer that is started after the CHO is initiated.

The transmission component 604 may transmit a CHO complete message after transmitting the bye message. The transmission component 604 may transmit a CHO complete message after the wait timer expires.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication. The apparatus 700 may be a network entity, such as a base station in a source cell (e.g., gNB 310), or a network entity may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, a network entity, or another wireless communication device) using the reception component 702 and the transmission component 704. As further shown, the apparatus 700 may include the communication manager 150. The communication manager 150 may include a data forwarding component 708, among other examples.

In some aspects, the apparatus 700 may be configured to perform one or more operations described herein in connection with FIGS. 1-3. Additionally, or alternatively, the apparatus 700 may be configured to perform one or more processes described herein, such as process 500 of FIG. 5. In some aspects, the apparatus 700 and/or one or more components shown in FIG. 7 may include one or more components of the base station described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the base station described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the base station described in connection with FIG. 2. In some aspects, the transmission component 704 may be co-located with the reception component 702 in a transceiver.

The reception component 702 may receive, from a UE before initiation of a CHO, a bye message that indicates that the UE is preparing to leave the source cell for a target cell. The data forwarding component 708 may forward data to one or more prepared CHO target cells based at least in part on the bye message. The transmission component 704 may transmit a response to the bye message.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

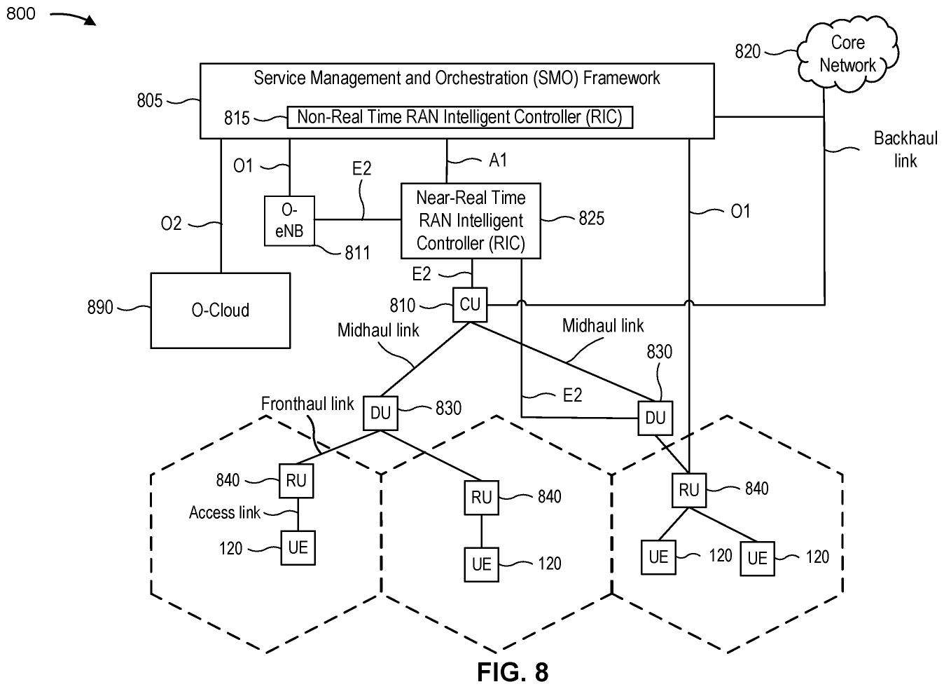

FIG. 8 is a diagram illustrating an example of a disaggregated base station 800, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 800 architecture may include one or more CUs 810 that can communicate directly with a core network 820 via a backhaul link, or indirectly with the core network 820 through one or more disaggregated base station units (such as a Near-RT RIC 825 via an E2 link, or a Non-RT RIC 815 associated with a Service Management and Orchestration (SMO) Framework 805, or both). A CU 810 may communicate with one or more DUs 830 via respective midhaul links, such as an F1 interface. The DUs 830 may communicate with one or more RUs 840 via respective fronthaul links. The fronthaul link, the midhaul link, and the backhaul link may be generally referred to as “communication links.” The RUs 840 may communicate with respective UEs 120 via one or more RF access links. In some aspects, the UE 120 may be simultaneously served by multiple RUs 840. The DUs 830 and the RUs 840 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUs 810, the DUs 830, the RUs 840, as well as the Near-RT RICs 825, the Non-RT RICs 815 and the SMO Framework 805) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 810 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 810. The CU 810 may be configured to handle user plane functionality (i.e., Central Unit—User Plane (CU-UP)), control plane functionality (i.e., Central Unit—Control Plane (CU-CP)), or a combination thereof. In some implementations, the CU 810 can be logically split into one or more CU-UP units and one or more CU-CP units. The CU-UP unit can communicate bidirectionally with the CU-CP unit via an interface, such as the E1 interface when implemented in an O-RAN configuration. The CU 810 can be implemented to communicate with the DU 830, as necessary, for network control and signaling.

The DU 830 may correspond to a logical unit that includes one or more base station functions to control the operation of one or more RUs 840. In some aspects, the DU 830 may host one or more of a radio link control (RLC) layer, a MAC layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 830 may further host one or more low PHY layers. Each layer (or module) can be implemented with an interface configured to communicate signals with other layers (and modules) hosted by the DU 830, or with the control functions hosted by the CU 810.

Lower-layer functionality can be implemented by one or more RUs 840. In some deployments, an RU 840, controlled by a DU 830, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 840 can be implemented to handle over the air (OTA) communication with one or more UEs 120. In some implementations, real-time and non-real-time aspects of control and user plane communication with the RU(s) 840 can be controlled by the corresponding DU 830. In some scenarios, this configuration can enable the DU(s) 830 and the CU 810 to be implemented in a cloud-based RAN architecture, such as a vRAN architecture.

The SMO Framework 805 may be configured to support RAN deployment and provisioning of non-virtualized and virtualized network elements. For non-virtualized network elements, the SMO Framework 805 may be configured to support the deployment of dedicated physical resources for RAN coverage requirements which may be managed via an operations and maintenance interface (such as an O1 interface). For virtualized network elements, the SMO Framework 805 may be configured to interact with a cloud computing platform (such as an open cloud (O-Cloud) 890) to perform network element life cycle management (such as to instantiate virtualized network elements) via a cloud computing platform interface (such as an O2 interface). Such virtualized network elements can include, but are not limited to, CUs 810, DUs 830, RUs 840 and Near-RT RICs 825. In some implementations, the SMO Framework 805 can communicate with a hardware aspect of a 4G RAN, such as an open eNB (O-eNB) 811, via an O1 interface. Additionally, in some implementations, the SMO Framework 805 can communicate directly with one or more RUs 840 via an O1 interface. The SMO Framework 805 also may include a Non-RT RIC 815 configured to support functionality of the SMO Framework 805.

The Non-RT RIC 815 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 825. The Non-RT RIC 815 may be coupled to or communicate with (such as via an A1 interface) the Near-RT RIC 825. The Near-RT RIC 825 may be configured to include a logical function that enables near-real-time control and optimization of RAN elements and resources via data collection and actions over an interface (such as via an E2 interface) connecting one or more CUs 810, one or more DUs 830, or both, as well as an O-eNB, with the Near-RT RIC 825.

In some implementations, to generate AI/ML models to be deployed in the Near-RT RIC 825, the Non-RT RIC 815 may receive parameters or external enrichment information from external servers. Such information may be utilized by the Near-RT RIC 825 and may be received at the SMO Framework 805 or the Non-RT RIC 815 from non-network data sources or from network functions. In some examples, the Non-RT RIC 815 or the Near-RT RIC 825 may be configured to tune RAN behavior or performance. For example, the Non-RT RIC 815 may monitor long-term trends and patterns for performance and employ AI/ML models to perform corrective actions through the SMO Framework 805 (such as reconfiguration via 01) or via creation of RAN management policies (such as A1 policies).

As indicated above, FIG. 8 is provided as an example. Other examples may differ from what is described with regard to FIG. 8.

The following provides an overview of some Aspects of the present disclosure:

Aspect 1: A method of wireless communication performed by a user equipment (UE), comprising: generating, based at least in part on a handover condition being satisfied, a message that indicates that the UE is preparing to leave a source cell for a target cell; and transmitting the message before a conditional handover (CHO) is initiated or during a wait timer that is started after the CHO is initiated.

Aspect 2: The method of Aspect 1, wherein the method further comprises monitoring for a response to the message until the wait timer expires.

Aspect 3: The method of Aspect 1 or 2, further comprising transmitting a CHO complete message after transmitting the message.

Aspect 4: The method of Aspect 1 or 2, further comprising transmitting a CHO complete message after the wait timer expires.

Aspect 5: The method of any of Aspects 1-4, wherein the handover condition includes reaching a configured time point within a time to trigger (TTT) for a measurement event used for the CHO.

Aspect 6: The method of any of Aspects 1-5, wherein the handover condition includes one or more of a threshold gradient of signal strength, a threshold gradient of signal quality, a threshold Doppler parameter, or a velocity of the UE.

Aspect 7: The method of any of Aspects 1-6, wherein the handover condition includes multiple measurement events.

Aspect 8: The method of any of Aspects 1-7, wherein transmitting the message includes transmitting the message in a radio resource control message, a medium access control control element (MAC CE), a scheduling request specific to handover, or a channel state information report specific to handover.

Aspect 9: The method of any of Aspects 1-8, wherein the message includes a cell identifier (ID) or a physical cell ID of a cell for which the CHO is to be initiated.

Aspect 10: The method of any of Aspects 1-9, wherein the message includes a configuration index that identifies the target cell.

Aspect 11: The method of any of Aspects 1-10, wherein transmitting the message includes transmitting the message in a primary cell.

Aspect 12: The method of any of Aspects 1-11, wherein transmitting the message includes transmitting the message in a secondary cell or a primary secondary cell.

Aspect 13: The method of any of Aspects 1-12, wherein transmitting the message includes transmitting the message to a secondary node in a dual connectivity mode for conditional primary secondary cell change.

Aspect 14: The method of any of Aspects 1-13, wherein transmitting the message includes transmitting the message to a relay station at the source cell.

Aspect 15: The method of Aspect 14, wherein transmitting the message includes transmitting the message in a PC5 message or a non-cellular message.

Aspect 16: The method of any of Aspects 1-15, wherein the CHO includes a dual active protocol stack handover.

Aspect 17: A method of wireless communication performed by a network entity of a source cell, comprising: receiving, from a user equipment (UE) before initiation of a conditional handover (CHO), a message that indicates that the UE is preparing to leave the source cell for a target cell; and forwarding data to one or more prepared CHO target cells based at least in part on the message.

Aspect 18: The method of Aspect 17, further comprising transmitting a response to the message.

Aspect 19: The method of Aspect 17 or 18, wherein the one or more prepared CHO target cells includes the target cell identified by a cell identifier in the message.

Aspect 20: The method of any of Aspects 17-19, wherein the one or more prepared CHO target cells includes multiple prepared CHO target cells if the message does not include a cell identifier.

Aspect 21: The method of any of Aspects 17-20, wherein receiving the message includes receiving the message in a radio resource control message, a medium access control control element, a scheduling request specific to handover, or a channel state information report.

Aspect 22: The method of any of Aspects 17-21, wherein the message includes a cell identifier of a cell for which the CHO is to be initiated.

Aspect 23: The method of any of Aspects 17-22, wherein the message includes a configuration index that identifies the target cell.

Aspect 24: The method of any of Aspects 17-23, wherein receiving the message includes receiving the message in a primary cell.

Aspect 25: The method of any of Aspects 17-24, wherein receiving the message includes receiving the message in a secondary cell or a primary secondary cell.

Aspect 26: The method of any of Aspects 17-25, wherein receiving the message includes receiving the message from a relay station.

Aspect 27: The method of any of Aspects 17-26, wherein the CHO includes a dual active protocol stack handover.

Aspect 28: An apparatus for wireless communication at a device, comprising a processor; memory coupled with the processor; and instructions stored in the memory and executable by the processor to cause the apparatus to perform the method of one or more of Aspects 1-27.

Aspect 29: A device for wireless communication, comprising a memory and one or more processors coupled to the memory, the one or more processors configured to perform the method of one or more of Aspects 1-27.

Aspect 30: An apparatus for wireless communication, comprising at least one means for performing the method of one or more of Aspects 1-27.

Aspect 31: A non-transitory computer-readable medium storing code for wireless communication, the code comprising instructions executable by a processor to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
generate, based at least in part on a handover condition being satisfied, a message that indicates that the UE is preparing to leave a source cell for a target cell; and
transmit the message before a conditional handover (CHO) is initiated or during a wait timer that is started after the CHO is initiated.

2. The UE of claim 1, wherein the one or more processors are configured to monitoring for a response to the message until the wait timer expires.

3. The UE of claim 1, wherein the one or more processors are configured to transmit a CHO complete message after transmitting the message.

4. The UE of claim 1, wherein the one or more processors are configured to transmit a CHO complete message after the wait timer expires.

5. The UE of claim 1, wherein the handover condition includes reaching a configured time point within a time to trigger (TTT) for a measurement event used for the CHO.

6. The UE of claim 1, wherein the handover condition includes one or more of a threshold gradient of signal strength, a threshold gradient of signal quality, a threshold Doppler parameter, or a velocity of the UE.

7. The UE of claim 1, wherein the handover condition includes multiple measurement events.

8. The UE of claim 1, wherein the one or more processors, to transmit the message, are configured to transmit the message in a radio resource control message, a medium access control control element (MAC CE), a scheduling request specific to handover, or a channel state information report specific to handover.

9. The UE of claim 1, wherein the message includes a cell identifier (ID) or a physical cell ID of a cell for which the CHO is to be initiated.

10. The UE of claim 1, wherein the message includes a configuration index that identifies the target cell.

11. The UE of claim 1, wherein the one or more processors, to transmit the message, are configured to transmit the message in a primary cell.

12. The UE of claim 1, wherein the one or more processors, to transmit the message, are configured to transmit the message in a secondary cell or a primary secondary cell.

13. The UE of claim 1, wherein the one or more processors, to transmit the message, are configured to transmit the message to a secondary node in a dual connectivity mode for conditional primary secondary cell change.

14. The UE of claim 1, wherein the one or more processors, to transmit the message, are configured to transmit the message to a relay station at the source cell.

15. The UE of claim 14, wherein the one or more processors, to transmit the message, are configured to transmit the message in a PC5 message or a non-cellular message.

16. The UE of claim 1, wherein the CHO includes a dual active protocol stack handover.

17. A network entity in a source cell for wireless communication, comprising:
a memory; and
one or more processors, coupled to the memory, configured to:
receive, from a user equipment (UE) before initiation of a conditional handover (CHO), a message that indicates that the UE is preparing to leave the source cell for a target cell; and
forward data to one or more prepared CHO target cells based at least in part on the message.

18. The network entity of claim 17, wherein the one or more processors are configured to transmit a response to the message.

19. The network entity of claim 17, wherein the one or more prepared CHO target cells includes the target cell identified by a cell identifier in the message.

20. The network entity of claim 17, wherein the one or more prepared CHO target cells includes multiple prepared CHO target cells if the message does not include a cell identifier.

21. The network entity of claim 17, wherein the one or more processors, to receive the message, are configured to receive the message in a radio resource control message, a medium access control control element (MAC CE), a scheduling request specific to handover, or a channel state information report specific to handover.

22. The network entity of claim 17, wherein the message includes a cell identifier of a cell for which the CHO is to be initiated.

23. The network entity of claim 17, wherein the message includes a configuration index that identifies the target cell.

24. The network entity of claim 17, wherein the one or more processors, to receive the message, are configured to receive the message in a primary cell.

25. The network entity of claim 17, wherein the one or more processors, to receive the message, are configured to receive the message in a secondary cell or a primary secondary cell.

26. The network entity of claim 17, wherein the one or more processors, to receive the message, are configured to receive the message from a relay station.

27. The network entity of claim 17, wherein the CHO includes a dual active protocol stack handover.

28. A method of wireless communication performed by a user equipment (UE), comprising:
generating, based at least in part on a handover condition being satisfied, a message that indicates that the UE is preparing to leave a source cell for a target cell; and
transmitting the message before a conditional handover (CHO) is initiated or during a wait timer that is started after the CHO is initiated.

29. The method of claim 28, wherein the method further comprises monitoring for a response to the message until the wait timer expires.

30. A method of wireless communication performed by a network entity of a source cell, comprising:
receiving, from a user equipment (UE) before initiation of a conditional handover (CHO), a message that indicates that the UE is preparing to leave the source cell for a target cell; and
forwarding data to one or more prepared CHO target cells based at least in part on the message.
